(19) United States
(12) Patent Application Publication
(10) Pub. No.: US 2024/0416844 A1
(43) Pub. Date: Dec. 19, 2024

(54) Mountable Stanchion

(71) Applicant: Porter Systems Inc., Novi, MI (US)

(72) Inventors: Christopher Marsh, Farmington Hill, MI (US); Michael Alan Blake, Plymouth, MI (US)

(21) Appl. No.: 18/210,078

(22) Filed: Jun. 15, 2023

(51) Int. Cl. B60R 9/058

(52) U.S. Cl. CPC B60R 9/058

(57) ABSTRACT

A mountable stanchion is disclosed. The mountable stanchion comprised of a housing; a support plate; a connector attaching the housing to the support plate; a lever; two rotational hook elements; and a plunger. The lever has a release end, a rotational end, and a blocker. The two rotational hook elements each has an axis of rotation; a latching cut-out, a hook member; and a locking nub. The hook members define a jaw which is sprung to be in the open position. The lever is spring to be in the up position. When a downward pressure is placed on the housing, the plunger hits the nubs, causing the jaws to close. The jaws can then be locked in place. The jaws mate with a channel bracket permanently secured to the roof of a vehicle.

### CLAIM OF PRIORITY

This application claims priority to U.S. Provisional Application No. 63/351,880 filed Jun. 14, 2023.

### FIELD OF INVENTION

This invention concerns securing or covering of load on vehicles. Specifically, this invention is a mountable and removable stanchions intended to be temporarily attached to a vehicle.

### BACKGROUND

There is a steady push to make motor vehicles as re-configurable as possible. Although fixed features were once acceptable, modern engineering requires re-configurable solutions. With respect to transporting loads on the roof of vehicles, there is demand for a system that allows the roof racks to be moved and removed. In order to do this, a mountable stanchion is required. The mountable stanchion must work in pairs, allowing rails to traverse the distance between the stanchions.

### SUMMARY

This summary is intended to disclose the present invention, a mountable stanchion. The embodiments and descriptions are used to illustrate the invention and its utility, and are not intended to limit the invention or its use. It is also not intended to limit the scope of the claimed subject matter. Certain terminology is used in the following description for convenience only and is not limiting. The article “a” is intended to include one or more items, and where only one item is intended the term “one” or similar language is used. To assist in the description of the present invention, words such as before, after, first, second, near, far, short, long, top, bottom, side, upper, lower, front, rear, inner, outer, right and left are used to describe the relative sequence, order, proximity, size, and orientation of aspects of the present invention, a mountable stanchion. The terminology includes the words above specifically mentioned, derivatives thereof, and words of similar import.

In a typical application, the mountable stanchions are deployed as a pair. The two stanchions are both attached to vehicle roof feature. The two stanchions, referred to as a left stanchion and a right stanchion, are located directly across from one another on a vehicle roof.

Each mountable stanchion has a latching mechanism that engages with a bracket that is permanently affixed to the vehicle roof. Each latching mechanism has two opposing rotational hook elements that terminate in hook members. Each pair can be conceived of as a jaw In their open position, jaws are a first distance apart. In their closed position, the jaws are a second, shorter distance apart.

When the mountable stanchion is engaged with the bracket, the two rotational hook elements rotate in opposite directions. As one looks at the assembly, the right rotational hook element rotates counterclockwise to close and the left rotates clockwise. This is true regardless of whether one looks at the assembly from the front or the back.

Once the jaws are closed to a certain point, a “blocker” or pawl, drops down into position between the rotational hook elements, at the top of the rotational hook elements, on the opposite of the hook pivots. This blocker will stop the hooks from opening up, hence the name blocker. Lifting up the blocker will release the jaws, which are normally sprung open, causing the jaws to open. The blocker is normally sprung downwards, so that as the jaws close, and the gap between the jaws opposite the jaw pivots start to open, the blocker will eventually push into the space between the rotational hook elements because it is sprung downwards normally.

### BRIEF DESCRIPTION OF THE DRAWINGS

The present invention is illustrated with 13 figures on 12 sheets. The accompanying drawings are incorporated in and constitute a part of this disclosure. The figures are intended to illustrate various embodiments of the invention. The present invention, mountable stanchions, is comprised of two stanchions which can be mounted and removed from a vehicle. Primarily, the invention is intended to be used on the roof of the vehicle.

FIG. 1 is a front view of the first embodiment of the mechanism and housing.

FIG. 2 is a front view of the first embodiment of the mechanism, only, with the jaws closed.

FIG. 3 is a front view of the first embodiment of the mechanism, only, with the jaws opened.

FIG. 4 is a front view of the second embodiment of the mechanism, only, with the jaws closed.

FIG. 5 is a front view of the second embodiment of the mechanism, only, with the jaws open.

FIG. 6 is a front view of the second embodiment of the mechanism paired with a second embodiment of the housing and a lock, with the jaws closed.

FIG. 7 is a front view of the second embodiment of the mechanism paired with a second embodiment of the housing and a lock, with the jaws open.

FIG. 8 is an isolation side view of a locking mechanism.

FIG. 9 is an in situ of the invention attached to the roof side rail.

FIG. 10A is a rear view of an alternative embodiment mechanism and housing. FIG. 10B is a perspective view of an alternative embodiment mechanism engaged. FIG. 10C is a front view of an alternative embodiment mechanism engaged.

FIG. 11A shows an alternative embodiment front view mechanism.

FIG. 11B shows an alternative embodiment rear view mechanism.

FIG. 12A shows how to engage the latching mechanism. FIG. 12B shows how the latching mechanism locks.

FIG. 13 shows how to disengage the latching mechanism.

### DETAILED DESCRIPTION

The following descriptions are not meant to limit the invention, but rather to add to the summary of invention, and illustrate the present invention, by offering and illustrating various embodiments of the present invention, a mountable stanchion 1, 100. While embodiments of the invention are illustrated and described, the embodiments herein do not represent all possible forms of the invention. Rather, the descriptions, illustrations, and embodiments are intended to teach and inform one skilled in the art without limiting the scope of the invention.

Certain terminology is used in the following description for convenience only and is not limiting. The article “a” is intended to include one or more items, and where only one item is intended the term “one” or similar language is used. To assist in the description of the present invention, words such as before, after, first, second, near, far, short, long, top, bottom, side, upper, lower, front, rear, inner, outer, right and left are used to describe the relative sequence, order, proximity, size, and orientation of aspects of the present invention, mountable stanchions for protecting portable field-service equipment. The terminology includes the words above specifically mentioned, derivatives thereof, and words of similar import. Most applications use stanchions in even pairs, but it is certainly conceivable to use an odd number of stanchions.

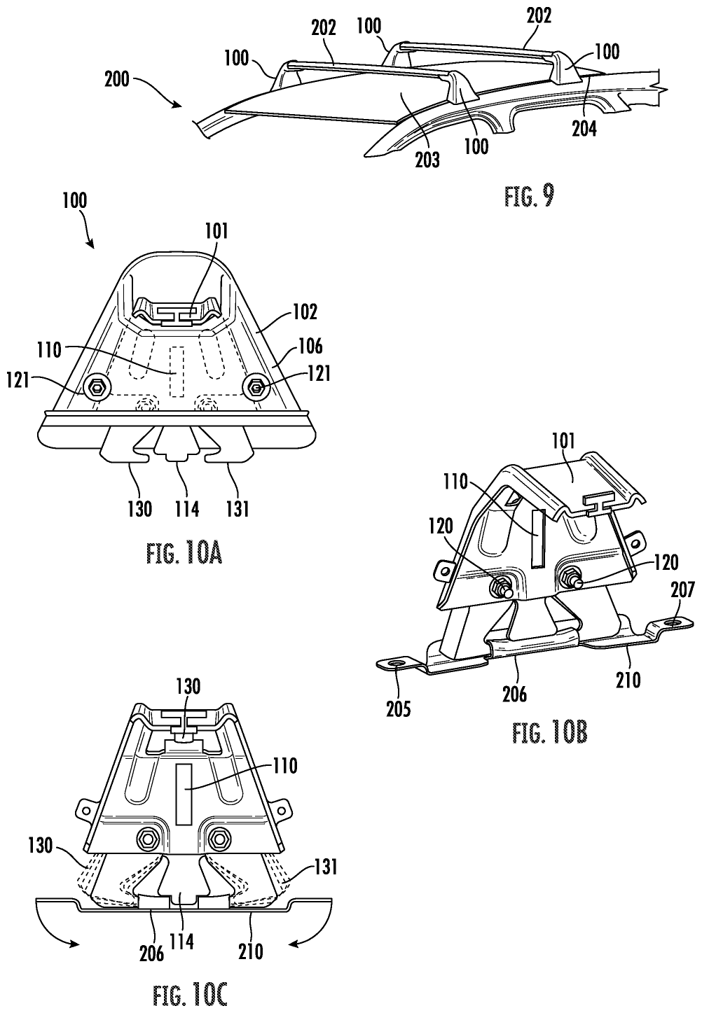

As shown in FIG. 9, in use, mountable stanchions 100 are deployed in pairs which are attached to a vehicle roof 200. The mountable stanchions 100 are attached to a mounting feature 204. The mountable stanchions 100 are disposed opposite one another on opposite sides of the roof surface 203. Each pair of stanchions 100 supports one cross-bar 202. The two stanchions 100, referred to as a left stanchion and a right stanchion, are located directly across from one another on a vehicle roof 200, 203.

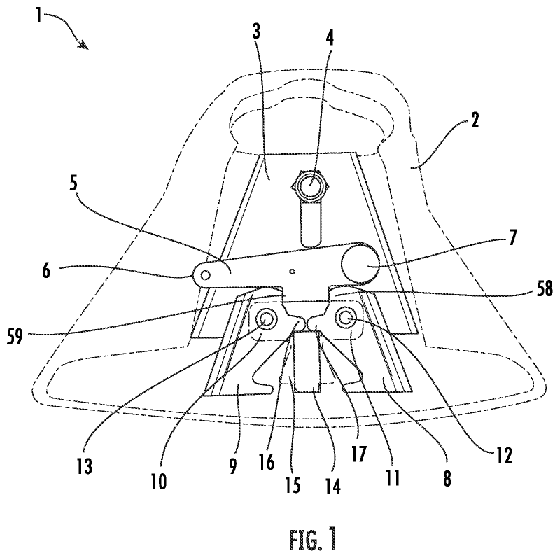

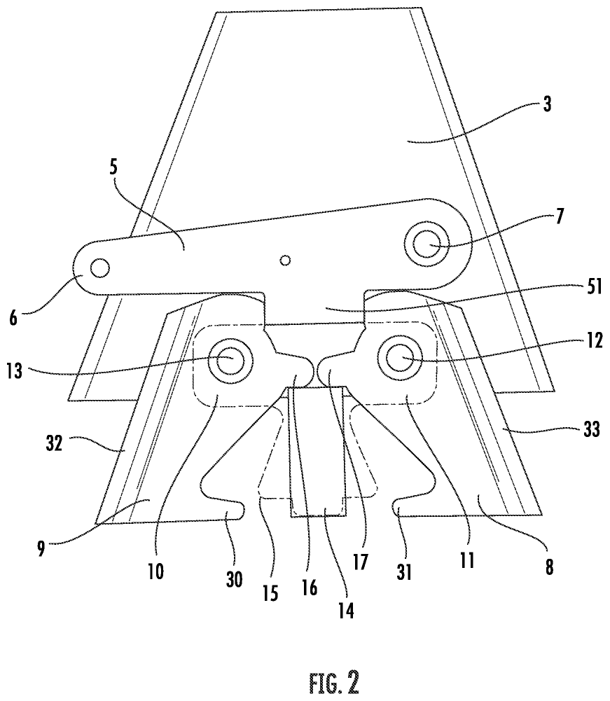

FIGS. 1-3 show the front side of a first embodiment of a single mountable stanchion 1. Calling this side the front side is arbitrary. The mountable stanchion is comprised of an outer surface called a housing 2, a support plate 3, a connector 4 attaching the housing 2 to the support plate 3, a lever 5, two rotational hook elements 9, 8, and a plunger 14. In this embodiment, the connector 4 is a threaded nut 4.

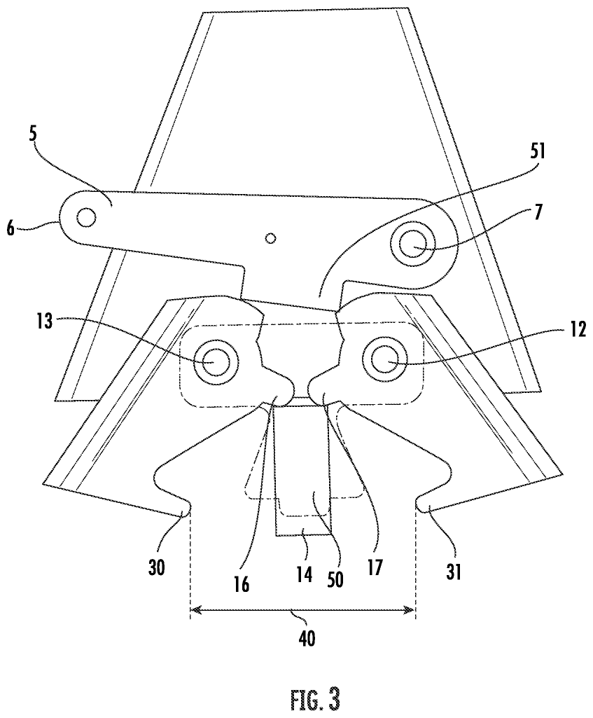

Looking at FIGS. 1, 2, and 3, the lever 5 has a rotational end 7, pivotably fixed to the support plate 3. The lever 5 also has a release end 6 and a blocker 51. The blocker 51 mates with a latching cut-out 59, 58 in each of the rotational hook elements 9, 8 to latch the rotational hook elements 9, 8 closed (FIG. 1). The blocker 51 latches the mountable stanchion 1 by preventing the rotational hook elements 9, 8 from rotating. When the release end 6 is raised, the blocker 51 no longer obstructs the latching cut-out 59, 58 of the rotational hook elements 9, 8, thereby allowing rotational hook elements 9, 8 to rotate (FIG. 3).

The two rotational hook elements 9, 8 each have a locking nub 16, 17 which mates with the blocker 51. The two rotational hook elements 9, 8 terminate in hook members 30, 31. The hook members 30, 31 of the rotational hook elements 9, 8 are called the rotational jaws 30, 31. The two rotational hook elements 9, 8 are attached to a spacer plate having a first rectangular sector 10, a second rectangular sector 11, and a triangular sector 15. The triangular sector 15 has a channel guide 50 that fits in a receiving channel of the bracket to which the mountable stanchion 1 is mounted. The first rotational hook element 9 is rotationally attached to the first rectangular sector 10 at a first axial connector 13. The second rotational hook element 8 is rotationally attached to the second rectangular sector 11 at a second axial connector 12. The axial connectors 13, 12 hold their respective rotational hook element 9, 8 in place while allowing them to rotate about the axial connectors 13, 12. The first rotational hook element 9 has a first stiffening feature 32. The second rotational hook element 8 has a second stiffening feature 33. The first and second stiffening features 32, 33 stiffen their respective rotational hook element 9, 8 so that when their respective hook members 30, 31 engage with the roof mounting bracket, the two rotational hook elements 9, 8 do not deform.

FIG. 3 shows the open position of the mountable stanchion 1. The two rotational hook elements 9, 8 have rotated so that their respective hook members 30, 31 are the farthest apart they can get. This is the open position. The open position is defined by the opened position length 40 between the hook members 30, 31. The plunger 14 is in the down position. This means that it is disposed as far from the lever as it can travel. In this example, the plunger 14 is capable of strictly linear movement-up and down. The plunger 14 is in the down position.

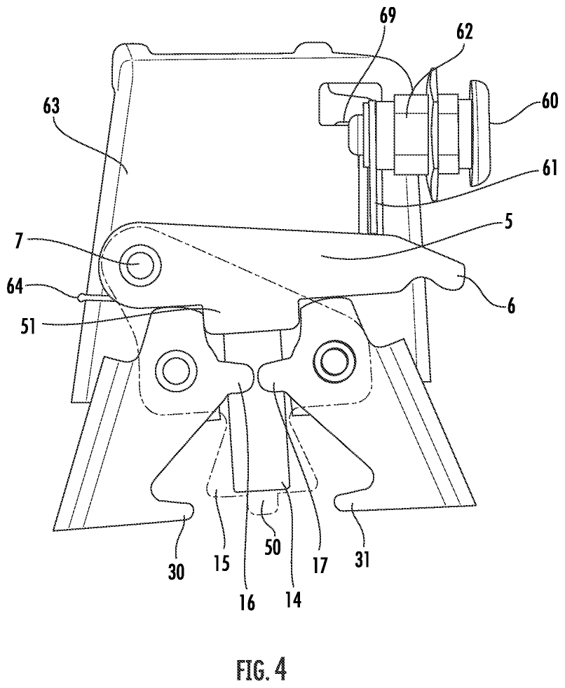

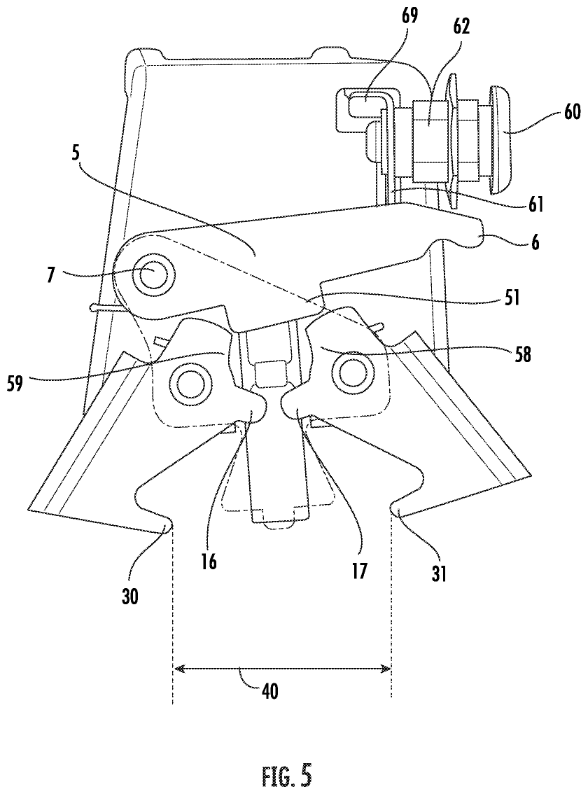

FIGS. 4-5 show an alternative embodiment of the mountable stanchion 1, this one with a locking feature. In this embodiment, the support plate 63 is re-configured. This view shows standard components: a lever 5 with a rotational end 7, a release end 6, and a blocker 51. In this embodiment, the lever 5 has been reversed to illustrate that the direction of the lever is immaterial to the design. Two rotational hook elements are shown with their respective hook members 30, 31, locking nubs 16, 17, and latching cut-outs 59, 58. In this embodiment, a second spacer plate 51 is added so that it also attaches to the lever 5 (the first spacer plate 10, 11, 15 is not shown so as to not obscure the second spacer plate 51). The spacer plate 51 still has a triangular sector 15 with a channel guide 50 that fits in a receiving channel of the bracket to which the mountable stanchion 1 is mounted. The terminal end of a lever tensioning spring 64 is visible.

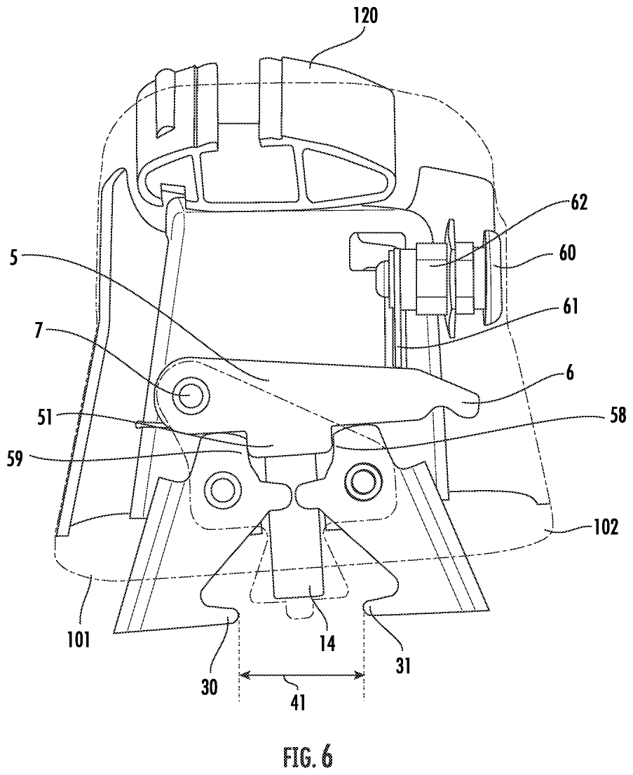

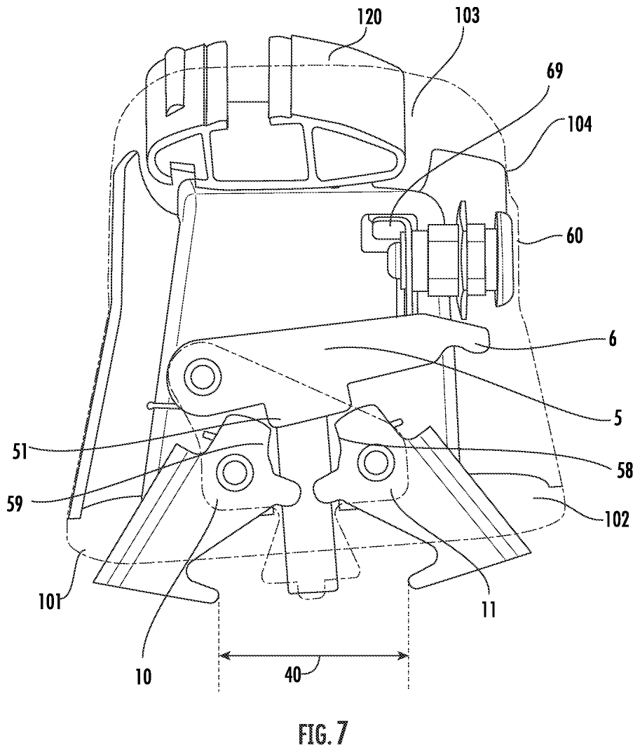

The locking mechanism 62 has a lock 60, a locking blade 61, and a visual indicator 69. When locked, as in FIG. 6, the locking blade 61 blocks the release end 6 of the lever 5. When unlocked, as in FIG. 7, the locking blade 61 does not block the lever 5.

FIGS. 6-7 shows the alternative embodiment of FIGS. 4-5 with the addition of the housing 401, with a perimeter 402, an upper segment 403, and a lower segment 404. A housing build like this would allow standardization of the lower segment 404 with customization of the upper segment 403. The perimeter is intended to sit flush on the vehicle roof 200. A coupler 420 is added to the housing 401 in order to couple a roof rack rail 202.

FIG. 6 shows the hook members 30, 31 in the closed position. The closed position is defined by the closed position length 41 between the hook members 30, 31. FIG. 7 shows the open position length 40. The closed position length 41 is smaller than the open position length 40.

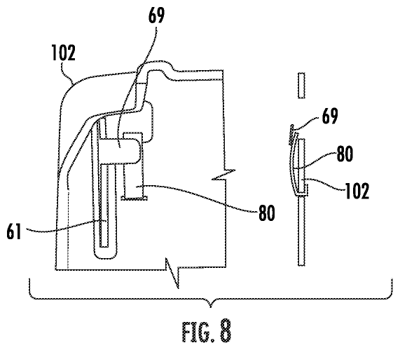

FIG. 8 is an isolated side view of the locking mechanism 62. Visible in this view is the lower segment of the stanchion housing 404. The return blade 69 is tensioned by a leaf spring 80. The leaf spring 80 is held in place with a crimp through the support plate 63. The locking blade 61 is in the locked position.

FIGS. 10A, 10B, and 10C show a third embodiment of the mountable stanchion 100. The support plate 102 has been re-configured to add features and remove the overall part count from the assembly. Notably, the support plate has a perpendicular section 101 that acts as direct making connection to a roof rail 202. The rotational jaws 130, 131 are attached directly to the re-configured support plate 102 with a threaded fastener 120 and nut 121 combination. The support plate 102 has a stiffening rib 106 on the edge and a window 110 in the center.

A mounting bracket 210 is attached to the vehicle roof 200 with fasteners at each end 205, 207. The rotational jaws 130, 131 engage a capture channel 206, securing the mountable stanchion 100 to the vehicle roof 200. A channel guide 114 from the mountable stanchion 100 fits in a cut-out in the capture channel 206.

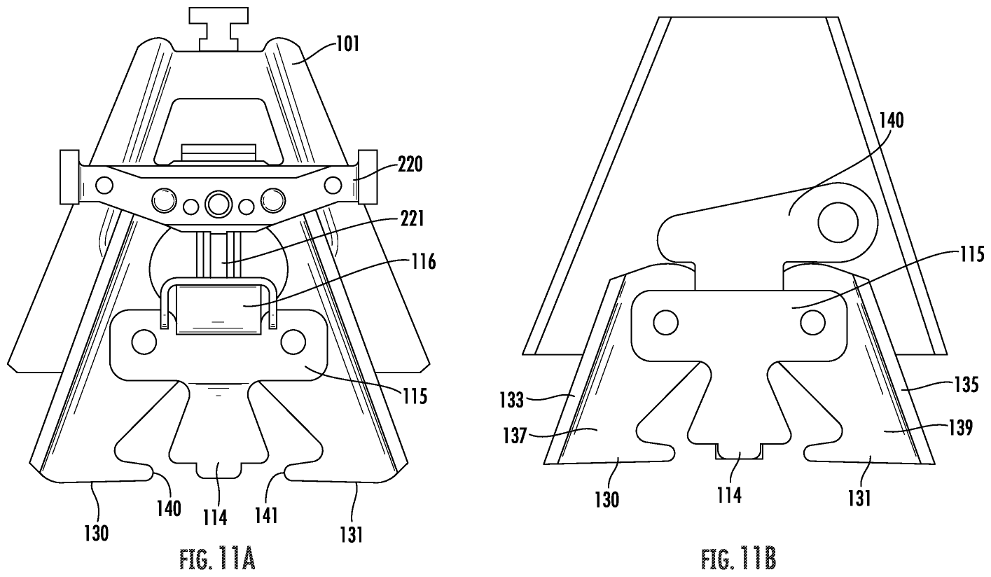

FIG. 11A shows an additional embodiment. Familiar elements are shown, which have been re-configured: the support plate 501, the rotational hook element 509, 508 with hook members 530, 531, and a channel guide 514. A modified first spacer bracket 515 is attached to a tensioner assembly 516, 521. A guide bracket 520 is used to accommodate the elongated rotational hook elements 509, 508.

FIG. 11B shows the first spacer bracket 55 with the second spacer bracket 51. All the other familiar elements of the rotational hook elements 9, 8, their respective hook members 30, 31, and their stiffening features 32, 33. A channel guide 50 is also shown.

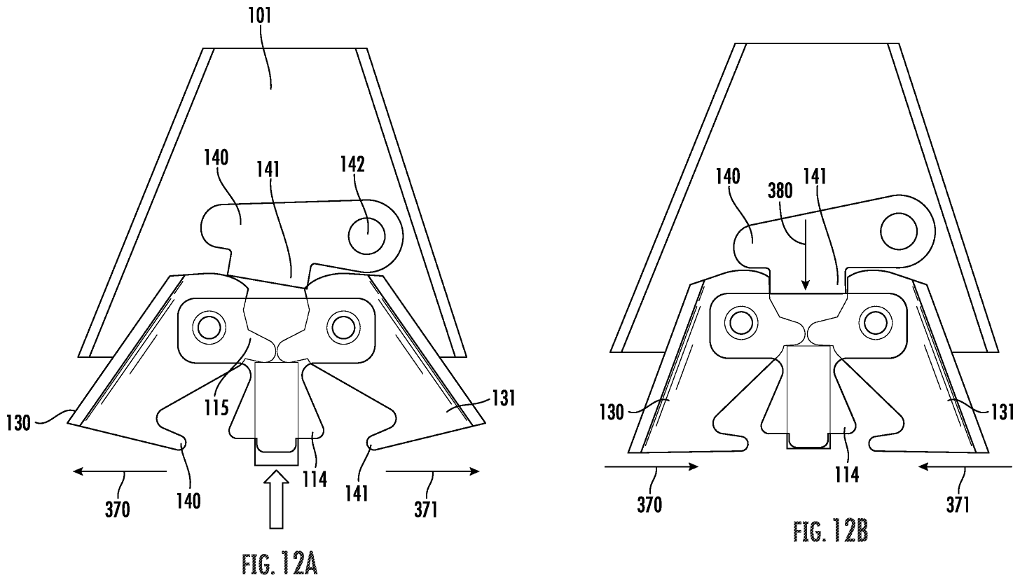

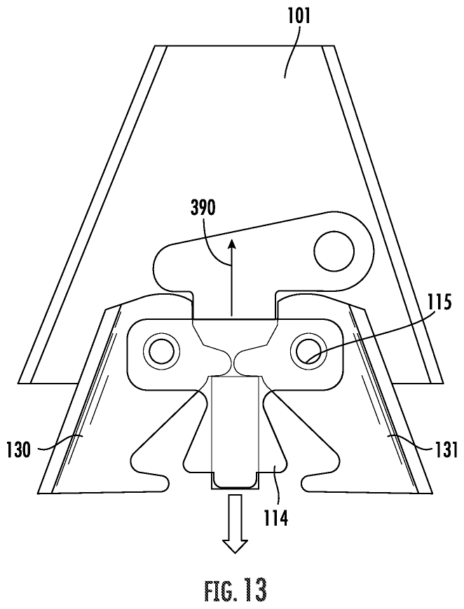

FIGS. 12A and 12B shows the force to mount the mountable stanchions. In FIG. 12A, when the support plate 101 is pressed downward, the plunger 114 is pushed upward and the jaws 140, 141 are sprung open 370. The lever 140 pivots about its rotational end 142. The blocker 141 is not blocking the jaws closed. In FIG. 12B, when the plunger 114 is fully up, the blocker 141 has downward force 380, which springs the jaws 140, 141 are sprung closed 371.

FIG. 13 shows how to disengage the invention. When the plunger 114 is free to move downward, the blocker experiences an upward force 390. The rotational jaws 130, 131 are then released to spring open by pivoting about their respective axes 115.

We claim:

1. A mountable stanchion comprised of
a housing;
a support plate;
a connector attaching the housing to the support plate;
a lever;
two rotational hook elements; and
a plunger;
wherein the lever has a release end, a rotational end, and a blocker;
wherein the two rotational hook elements each has an axis of rotation; a latching cut-out, a hook member; and a locking nub;
wherein the two hook members define a jaw;
wherein the two rotational hook elements are constrained to always rotate in opposite directions;
wherein an open position is defined by an open position length which in turn is defined as the distance between the two hook members when the two hook members are disposed a maximum distance from one another;
wherein a closed position is defined by a closed position length which in turn is defined as the distance between the two hook members when the two hook members are disposed a minimum distance from one another;
wherein the open position length is greater than the closed position length; and
wherein the two rotational hook elements are sprung to be in the open position as defined by the hook members being the open position length distance from one another.

2. The mountable stanchion of claim 1, wherein the blocker is sprung so that it is forced in a downward direction towards the two rotational hook elements.

3. The mountable stanchion of claim 2, wherein the plunger engages the nub of each rotational hook element.

4. The mountable stanchion of claim 3, wherein, when the plunger is pressed upwards, it causes the two rotational hook elements to rotate.

5. The mountable stanchion of claim 4, wherein, when the plunger is in the fully upward position, the blocker of the lever mates with the latching cut-out in each of the two rotational hook elements, preventing the rotational hook elements from rotating back to an open position, defining a closed position for the jaws.

6. The mountable stanchion of claim 5, further comprising a lock.

7. The mountable stanchion of claim 6, wherein, when in the locked position, a lock blade prevents the lever from moving upward.

8. The mountable stanchion of claim 5, wherein, when an upward pressure is put on the housing, the plunger releases, allowing the jaw to return to an open position.

9. The mountable stanchion of claim 5, wherein the closed jaws are mated with a channel in a bracket attached to the roof of a vehicle.
